(19) United States
(12) Patent Application Publication
(10) Pub. No.: US 2010/0030486 A1
(43) Pub. Date: Feb. 4, 2010

(54) Method and Apparatus for Determining at Least One Measured Variable of a Medium

(75) Inventors: Sergej Lopatin, Lorrach (DE); Helmut Pfeiffer, Steinen (DE)

Correspondence Address: BACON & THOMAS, PLLC, 625 SLATERS LANE, FOURTH FLOOR, ALEXANDRIA, VA, 22314-1176, US

(73) Assignee: Endress + Hauser GmbH +Co. KG, Maulburg (DE)

(21) Appl. No.: 12/086,644

(22) PCT Filed: Nov. 24, 2006
(86) PCT No.: PCT/EP2006/068906

§ 371 Date: Sep. 28, 2009

(30) Foreign Application Priority Data
Dec. 22, 2005 (DE) 102005062001.9

(51) Int. Cl. G06F 19/00; G01L 7/00

(52) U.S. Cl. 702/24; 702/54

(57) ABSTRACT

A method for determining and/or monitoring at least one measured variable of an at least partially gaseous medium with at least one mechanically oscillatable unit, which is excited to execute mechanical oscillations, and whose mechanical oscillations are received and evaluated. At least one characteristic curve is stored, which describes for at least one gas or a gas mixture at least the dependence of at least one characteristic variable of the mechanical oscillations of the mechanically oscillatable unit on pressure; at least the characteristic variable of the mechanical oscillations of the mechanically oscillatable unit is determined; the determined characteristic variable is compared with the stored characteristic curve; and, starting from the comparison of the determined characteristic variable with the stored characteristic curve, the measured variable of the medium is determined. Further, an apparatus for determining and/or monitoring the measured variable is envisioned.

The invention relates to a method and apparatus for determining and or monitoring at least one measured variable of an at least partially gaseous medium with at least one mechanically oscillatable unit, which is excited to execute mechanical oscillations and whose mechanical oscillations are received and evaluated. Additionally, the invention relates to an apparatus for determining and/or monitoring at least one measured variable of at an at least partially gaseous medium. The apparatus includes: At least one mechanically oscillatable unit, wherein the mechanically oscillatable unit includes at least one paddle, which comprises a predeterminable material of density (ρ), predeterminable surface of area (A) and predeterminable thickness (d); and at least one driving/receiving unit, which excites the mechanically oscillatable unit to execute oscillations and which receives the mechanical oscillations of the mechanically oscillatable unit.

For determining process variables of a medium, it is known in the state of the art to excite a mechanically oscillatable unit—for example, an oscillatory fork, a single rod or a membrane oscillator—to execute mechanical oscillations and then to detect these oscillations. The characteristics of the mechanical oscillations show, in such case, a dependence on the process variables, so that, from the oscillations, conclusions can be drawn concerning these variables. If, for instance, the medium is a liquid and fill level is the process variable to be determined or monitored, then it is advantageous to evaluate at least the frequency of the oscillations. If the oscillatable unit is oscillating freely and, especially, uncovered by the medium, then the resonance frequency is higher than in the case in which medium is covering the oscillator. In the case of bulk goods, the oscillation amplitude correspondingly decreases. Consequently, an oscillating sensor is optimally suited for determining process variables. Known in the state of the art are applications in the case of liquids and in the case of bulk goods.

An object of the invention is to determine and/or monitor different gases or gas mixtures with a measuring method, which is as cost effective and as robust as possible. A further object is to provide identification of a gas, or a gas mixture, without chemical analysis.

The invention achieves the object with a method for determining and/or monitoring at least one measured variable of an at least partially gaseous medium with at least one mechanically oscillatable unit, which is excited to execute mechanical oscillations and whose mechanical oscillations are received and evaluated. The method of the invention includes that: At least one characteristic curve is stored, which describes for at least one gas or gas mixture at least a dependence of at least one characteristic variable of the mechanical oscillations of the mechanically oscillatable unit on pressure; at least the characteristic variable of the mechanical oscillations of the mechanically oscillatable unit is determined; the determined characteristic variable is compared with the stored characteristic curve; and, starting from the comparison of the determined characteristic variable with the stored characteristic curve, the measured variable of the medium is determined. In the method of the invention, thus, a characteristic curve is produced and stored, which describes, for at least one gas or gas mixture, dependence of a characteristic variable of the mechanical oscillations on reigning pressure. Thus, at least one point is denoted, at which, at least for a gas or a value of concentration of a gas mixture, a certain value of the characteristic variable is associated with a particular pressure. Since the characteristic variable is determined from the mechanical oscillations, it is possible, with knowledge concerning the gas, or gas mixture, to deduce the pressure, or at least indicate a deviation from a pressure, as the case may be. If, in contrast, pressure is known, then the presence of a gas, or the concentration of this gas/gas mixture, can be deduced.

An embodiment of the method of the invention provides that pressure of the medium is determined as measured variable of the medium, which is a gas, or a gas mixture. In this first embodiment of the method, it is, thus, known what the gas, or gas mixture, is, or which concentration is given. This permits deducing, from the characteristic variable of the oscillations, the pressure of the medium, or pressure of the gas/gas mixture, as the case may be. Thus, this embodiment involves a method for determining pressure of a gas, or a gas mixture. An opportunity for an example of an application here is a gas line, through which a known gas flows.

An embodiment of the method of the invention includes that: As measured variable of the medium, the presence of a gas within the medium, and/or a concentration of a gas within the medium in the form of a gas mixture, is determined; at least the pressure of the medium is measured; the determined characteristic variable is compared with the stored characteristic curve, which describes the dependence of the characteristic variable on pressure of at least one gas and/or pressure for at least one concentration of at least one gas mixture; and, starting from the comparison of the determined characteristic variable with the stored characteristic curve, the gas and/or the concentration of the gas mixture is determined. This second variant of the method makes use of the fact that gases, or gas mixtures, as the case may be, behave differently at known pressures and also effect the mechanical oscillations differently, so that, from the oscillations at known pressure, the kind of gas, or the presence of a gas, or the concentration of a gas mixture, as the case may be, can be deduced. Thus, involved, in this case, is a method for identifying a gas and/or determining a concentration of at least one gas in a gas mixture. This requires also that the pressure of the gas is measured. An opportunity for an example of an application here is a container filled with a known gas or a known gas mixture. The measurement methods permits deducing whether concentration is changing, when, for example, the process is running under deviation from predetermined parameters or whether a leakage is present in the process.

The following embodiments relate equally to the two above-described variants.

An embodiment of the method of the invention provides that frequency is determined as characteristic variable of the mechanical oscillations. Other characteristic variables can be amplitude or phase relative to the exciting signal of the oscillations.

An embodiment of the method of the invention includes that temperature of the medium is measured, and that the measured temperature is taken into consideration in determining the measured variable. Temperature usually affects gases, so that determining temperature makes the measuring more exact and/or also permits application at different temperatures.

An embodiment of the method of the invention provides that the determined, measured variable is compared with at least one stored, desired value and that, in the case of a deviation of the determined, measured variable from the stored, desired value, a signal is produced. In this embodiment, primarily a monitoring of the measured variable is assumed by the method.

The invention achieves the object also by an apparatus for determining and/or monitoring at least one measured variable of an at least partially gaseous medium. The apparatus includes: At least one mechanically oscillatable unit, wherein the mechanically oscillatable unit has at least one paddle of a predeterminable material of density (ρ), predeterminable surface of area (A) and predeterminable thickness (d); and at least one driving/receiving unit, which excites the mechanically oscillatable unit to execute oscillations and which receives the mechanical oscillations of the mechanically oscillatable unit. The invention resides, in such case, in the features that the product of thickness (d) and density (ρ) of the paddle is as small as possible, and that the area (A) of the paddle (2) is as large as possible. A change of the oscillation frequency (F_{Medium} relative to the frequency in vacuum F_{vacuum}) of an oscillatory fork can be described as follows:

$$\frac{{F}_{Medium}}{{F}_{Vacuum}} = \sqrt{\frac{1}{1 + K \cdot {ρ}_{Medium}}}$$

In such case, ρ_{Medium} is the density of the medium and K a sensitivity constant, which depends on the embodiment of the oscillatable unit as follows:

$$K = \frac{{c}_{1} \cdot a + {c}_{2}}{d \cdot ρ}$$

In such case, the factor a is the width of the tines of the oscillatory fork, d is the thickness of the tines and ρ the density of the material of which the fork tines are made. As can be seen, the sensitivity of the measurement increases, when K is large, i.e. when the product of the thickness of the tines and the density of the material being used is small and the width of the tines is as large as possible. In other words, the fork tines should be as light and as thin as possible. Especially in the case of gases, it is important to have the sensitivity as large as possible. Conversely, a gas, for example in contrast with a bulk good, permits use of an oscillatable unit, which, through a lower density, is also less robust.

An embodiment of the apparatus of the invention includes that the product of thickness (d) and density (ρ) referenced to the area (A) of the paddle is smaller than 0.34 g/cm. This means that, in the case of an area of 1 cm², the product of density and thickness is smaller than 0.34 g/cm.

An embodiment of the apparatus of the invention provides that the thickness (d) of the paddle is smaller than 1 cm.

An embodiment of the apparatus of the invention includes that the thickness (d) of the paddle is smaller than 1 millimeter.

An embodiment of the apparatus of the invention provides that the density (ρ) of the paddle is smaller than 8.5 g/cm³. This value holds for most varieties of steel.

An embodiment of the apparatus of the invention includes that the paddle consists essentially of a ceramic or a glass or a plastic. These materials provide low density, but, simultaneously, also robustness.

The invention will now be explained in greater detail on the basis of the appended drawings, the figures of which show as follows:

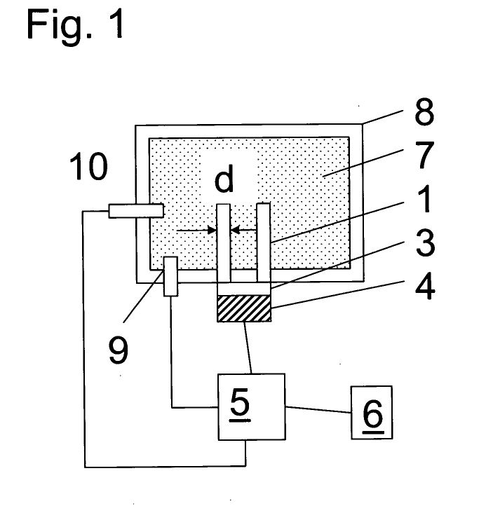

FIG. 1 a schematic view of a measurement set-up;

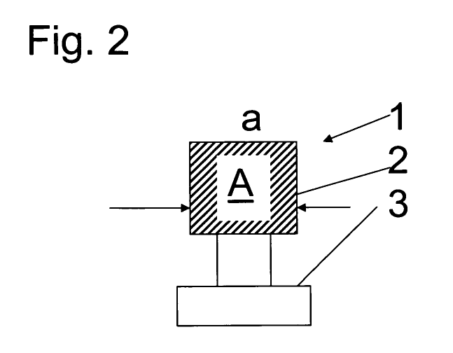

FIG. 2 a section through an oscillatable unit;

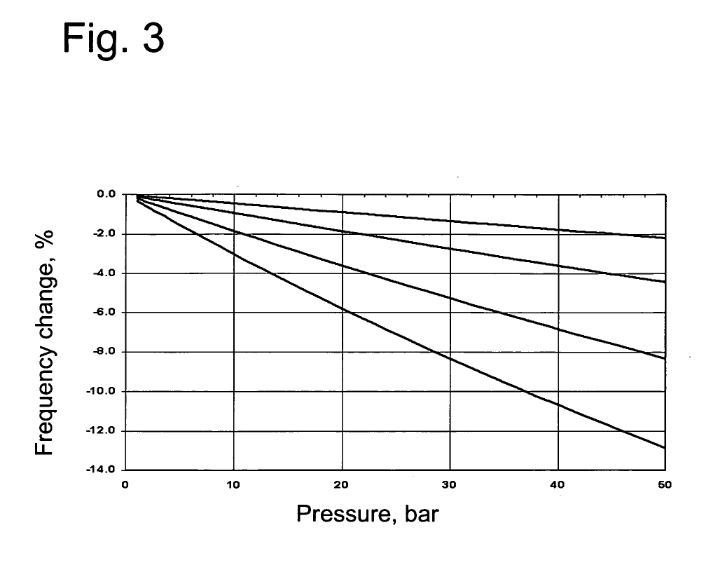

FIG. 3 a graphical presentation of frequency change as a function of pressure for different thicknesses of paddle; and

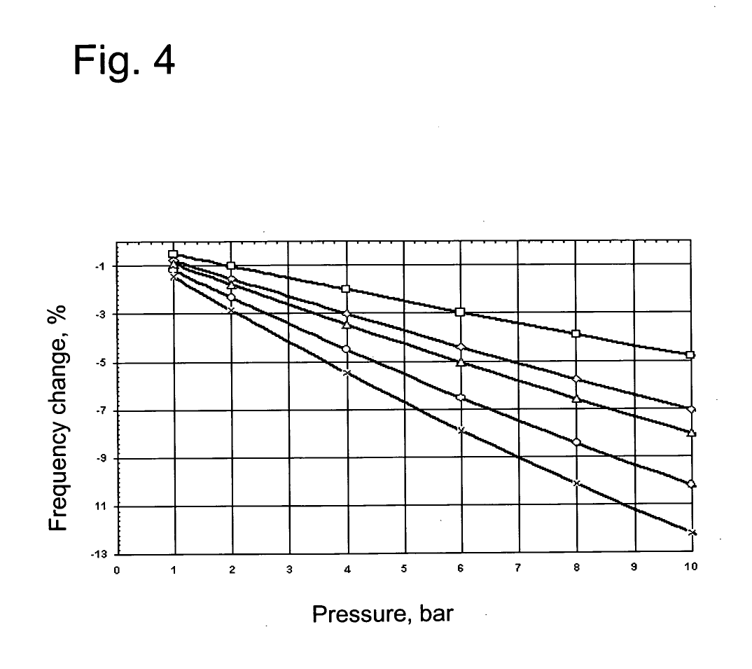

FIG. 4 a presentation as in FIG. 3 for different gases.

FIG. 1 shows a container 8, which is filled with a gas mixture as medium 7. Gas 7 is being monitored and/or measured by a measuring device having a mechanically oscillatable unit 1. In this instance, the mechanically oscillatable unit includes two fork tines secured to a membrane 3. There follows against membrane 3 a driving/receiving unit 4, based, for example, on a piezoelectric element. Driving/receiving unit 4 is supplied, for example, with an electric, alternating voltage, this leading to its executing mechanical oscillations, which are transmitted via membrane 3 to the fork tines. The mechanical oscillations detected by the driving/receiving unit 4 are, in turn, converted into an electrical, alternating voltage, which is evaluated by the evaluation/control unit 5. From the oscillations, for example, frequency, amplitude or even phase can be determined as characteristic variable. The characteristic variable of the oscillations is, in such case, at least dependent on the identity of the gas and the pressure in the gas. If these two variables are known, then the remaining variable can be determined from the measured characteristic variable. Here, a pressure sensor 10 is provided, which measures the pressure in the container 8 and thus the pressure of the medium 7. This pressure measured-value is supplied to the evaluation/control unit 5 and, there, a comparison with characteristic curves stored in a memory unit 6 can take place. In this way, it is possible to detect the concentration of a gas mixture or, alone, the presence of a certain gas in the container 8. Also storable in the memory unit 6 are desired values, upon whose exceeding by the measured value, for example, an alarm or a switching signal is output. For example, if the desired value for a gas is 0 and a concentration greater than 0 results, then already the presence of the gas is detected. With this arrangement, for example, a leakage in a gas tank can be detected, in that a concentration change of the present gas, or the in-streaming of another gas, is detected. Since the medium primarily involves a gas, also temperature dependence is to be heeded. Thus, here, also a temperature sensor 9 is provided.

In measuring pressure by the measuring device, it is to be assured that the composition of the medium remains the same. The pressure sensor 10 shown here would then serve, for example, for redundancy or for validation.

The fork tines are shown here from the side and have in such view a thickness d. FIG. 2 shows a front view of a paddle 2, so that its area A of breadth a is visible. The sensitivity of the measuring device can be increased by making the paddle 2 as thin as possible and by giving it an area A having a breadth a as large as possible.

Additionally, the paddles should be manufactured from a material of low density ρ. High sensitivity is especially important in the measurement of gases.

Since the sensor has a high sensitivity, it can also serve for detecting water condensate, deposition of ice, or dust deposition in process container 8.

The dependence of relative frequency change on pressure is presented in FIG. 3 for air at 20° C. The greater the pressure, the greater is the change in oscillation frequency. The slope of this characteristic curve depends, in such case, strongly on the thickness of the paddle 2. The paddles have, from below to above, the following thicknesses: 0.3 mm, 0.5 mm, 1.0 mm and 2.1 mm. As can be seen, a thinner paddle 2 is better, since the measuring sensitivity is greater. As also quite noticeable, measurement of the frequency of the oscillations permits the reigning pressure to be deduced. Shifting of the curves by different temperatures is, in such case, to be appropriately taken into consideration in practice. I.e. these curves are ideally suited for pressure measurement.

FIG. 4 shows corresponding curves for different gases. From below to above, these are: Coolant R22, butane, propane, CO2 and air. Thus, if pressure is known and frequency change of the oscillations is measured, then it can be determined, which gas is present. Consequently, the measuring apparatus permits implementation of a gas detection, such that the presence of a certain gas is recognized and also the concentration of a gas mixture is given.

List of Reference Characters

1 mechanically oscillatable unit

2 paddle

3 membrane

4 driving/receiving unit

5 evaluation/control unit

6 memory unit

7 medium

8 container

9 temperature sensor

10 pressure sensor

1-12. (canceled)

13. A method for determining and/or monitoring at least one measured variable of an at least partially gaseous medium with at least one mechanically oscillatable unit, which is excited to execute mechanical oscillations and whose mechanical oscillations are received and evaluated, comprising the steps of:
storing at least one characteristic curve, which describes for at least one gas or gas mixture at least the dependence of at least one characteristic variable of the mechanical oscillations of the mechanically oscillatable unit on pressure;
determining at least the characteristic variable of the mechanical oscillations of the mechanically oscillatable unit;
comparing the determined characteristic variable with the stored characteristic curve; and
determining, starting from the comparison of the determined characteristic variable with the stored characteristic curve, the measured variable of the medium.

14. The method as claimed in claim 13, wherein:
the pressure of the medium is determined as a measured variable of the medium, which is a gas or a gas mixture.

15. The method as claimed in claim 13, wherein:
the presence of a gas and/or a concentration of a gas within the medium is determined as a measured variable of the medium, which is a gas mixture;
at least a pressure of the medium is measured;
the determined characteristic variable is compared with the stored characteristic curve describing dependence of the characteristic variable on a pressure of at least one gas and/or on pressure for at least a concentration of at least one gas mixture; and
starting from the comparison of the determined characteristic variable with the stored characteristic curve, the gas and/or the concentration of the gas mixture is determined.

16. The method as claimed in claim 14, wherein:
frequency is determined as a characteristic variable of the mechanical oscillations.

17. The method as claimed in claim 14, further comprising the steps of:
measuring the temperature of the medium; and
taking the measured temperature into consideration in determining the measured variable.

18. The method as claimed in claim 14, further comprising the steps of:
comparing the determined, measured variable with at least one stored, desired value; and
producing a signal from a deviation of the determined, measured variable from the stored, desired value.

19. An apparatus for determining and/or monitoring at least one measured variable of an at least partially gaseous medium, comprising:
at least one mechanically oscillatable unit, which includes at least one paddle of predeterminable material of density, predeterminable surface of area and predeterminable thickness; and
at least one driving/receiving unit, which excites said mechanically oscillatable unit to execute mechanical oscillations and which receives the mechanical oscillations of said mechanically oscillatable unit, wherein:
the product of thickness and density of said paddle is as small as possible; and the area of said paddle is as large as possible.

20. The apparatus as claimed in claim 19, wherein:
the product of the thickness and density referenced to the area of said paddle is smaller than 0.34 g/cm.

21. The apparatus as claimed in claim 19, wherein:
the thickness of said paddle is less than 1 cm.

22. The apparatus as claimed in claim 21, wherein:
the thickness of said paddle is less than 1 millimeter.

23. The apparatus as claimed in claim 19, wherein:
the density of said paddle is less than 8.5 g/cm³.

24. The apparatus as claimed in claim 19, wherein:
said paddle consists essentially a ceramic or a glass or a plastic.
